(19) United States
(12) Patent Application Publication
(10) Pub. No.: US 2025/0299069 A1
(43) Pub. Date: Sep. 25, 2025

(54) PREDICTING RECHARGEABLE BATTERY LIFE USING A TWO-HEADED AUTOENCODER

(71) Applicant: Toyota Motor Engineering & Manufacturing North America, Inc., Plano, TX (US)

(72) Inventors: Alexander T. Pham, San Jose, CA (US); Nathan Sun, Greer, SC (US); Karena Yan, Morganville, NJ (US); Sara Sameer, Karachi (PK); Constantin-Daniel Nicolae, Mangalia (RO)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/613,706

(22) Filed: Mar. 22, 2024

(51) Int. Cl. G06N 5/022; G06N 20/00

(52) U.S. Cl. CPC G06N 5/022; G06N 20/00

(57) ABSTRACT

Systems and methods described herein relate to implementing battery life prediction strategies. In one embodiment, a method includes receiving a first battery dataset for a first set of rechargeable batteries that includes battery life measurements for the first set of rechargeable batteries, and training a two-headed autoencoder coupled to an elastic net module to predict battery life based on the first battery dataset, such that the two-headed autoencoder when trained is capable of receiving a second battery dataset for a second set of rechargeable batteries, determining statistical measures of a set of differential voltage-discharge curves over a range of discharge cycles based on the second battery dataset, and utilizing the two-headed autoencoder to predict battery life for at least one rechargeable battery of the second set of rechargeable batteries.

### TECHNICAL FIELD

The subject matter described herein relates, in general, to strategies for predicting rechargeable battery life, and, more particularly, to using a two-headed autoencoder trained to predict rechargeable battery life based on statistical features of differential voltage-discharge curves.

### BACKGROUND

As machines and devices become more dependent on rechargeable batteries for their power source, predicting battery life is an important activity. Various methods for predicting battery life have been proposed based on models of battery physics and chemistries, which may be difficult to implement in real life scenarios.

### SUMMARY

In one embodiment, a system is disclosed. The system includes one or more processors and a memory communicably coupled to the one or more processors. The memory stores a command module including instructions that when executed by the one or more processors cause the one or more processors to: receive a first battery dataset for a first set of rechargeable batteries that includes battery life measurements for the first set of rechargeable batteries, and train a two-headed autoencoder coupled to an elastic net module to predict battery life based on the first battery dataset, such that the two-headed autoencoder when trained is capable of receiving a second battery dataset for a second set of rechargeable batteries, determining statistical measures of a set of differential voltage-discharge curves over a range of discharge cycles based on the second battery dataset, and utilizing the two-headed autoencoder to predict battery life for at least one rechargeable battery of the second set of rechargeable batteries. In one embodiment, a non-transitory computer-readable medium including instructions that when executed by one or more processors cause the one or more processors to perform one or more functions is disclosed. The instructions include instructions to receive a first battery dataset for a first set of rechargeable batteries that includes battery life measurements for the first set of rechargeable batteries, and train a two-headed autoencoder coupled to an elastic net module to predict battery life based on the first battery dataset, such that the two-headed autoencoder when trained is capable of receiving a second battery dataset for a second set of rechargeable batteries, determining statistical measures of a set of differential voltage-discharge curves over a range of discharge cycles based on the second battery dataset, and utilizing the two-headed autoencoder to predict battery life for at least one rechargeable battery of the second set of rechargeable batteries.

In one embodiment, a method for implementing battery life prediction strategies is disclosed. In one embodiment, the method includes receiving a first battery dataset for a first set of rechargeable batteries that includes battery life measurements for the first set of rechargeable batteries, and training a two-headed autoencoder coupled to an elastic net module to predict battery life based on the first battery dataset, such that the two-headed autoencoder when trained is capable of receiving a second battery dataset for a second set of rechargeable batteries, determining statistical measures of a set of differential voltage-discharge curves over a range of discharge cycles based on the second battery dataset, and utilizing the two-headed autoencoder to predict battery life for at least one rechargeable battery of the second set of rechargeable batteries.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1A illustrates one example of a charging and discharging cycle for a rechargeable battery.

FIG. 1B illustrates one example of a discharged capacity vs. voltage curve for a rechargeable battery.

FIG. 2A illustrates one example of how discharged capacity of a rechargeable battery may decrease with each discharging cycle.

FIG. 2B illustrates one example of a differential discharge-voltage curve for a rechargeable battery.

FIG. 3A illustrates one example of a set of differential discharge-voltage curves for a set of batteries.

FIG. 3B illustrates one example of a set of variance measurements with respect to differential discharge-voltage curves for a set of batteries.

FIG. 4 illustrates one embodiment of a two-headed autoencoder within which systems and methods disclosed herein may be implemented.

FIG. 5 illustrates one embodiment of a battery life prediction system within which systems and methods disclosed herein may be implemented.

FIG. 6 illustrate one example of prediction performance by a two-headed autoencoder.

### DETAILED DESCRIPTION

Predicting battery life with respect to rechargeable batteries can require addressing a number of difficulties, such as different aging mechanisms as well as application and environmental factors arising from the use of the batteries. Nonetheless, being able to predict battery life may provide advantages, such as detecting batteries that may yield an insufficient battery life for a particular use. For example, rejecting batteries that may not last for a vehicle's warranty period may substantially reduce the cost of warranty repairs.

Accordingly, systems and methods are described herein for predicting battery life for rechargeable batteries, such as lithium-ion batteries. Since rechargeable batteries may have a battery life lasting for hundreds or thousands of cycles, taking voltages measurements for a limited number of discharge cycles may allow for prediction of the total number of discharge cycles that the battery will provide before reaching the end of its lifetime.

For example, based on these voltage measurements for each discharge cycle, discharge-voltage curves may be generated that allow for comparison across discharge cycles in the form of differential discharge-voltage curves (e.g., where the discharge-voltage curve at the 100th cycle is subtracted from the discharge-voltage curve at 10th cycle). Once such differential discharge-voltage curves are available, time series analysis of statistical features of those curves for a range of discharge cycles may be used to estimate battery life, such as through the use of a two-headed autoencoder.

With respect to the systems and methods described herein, a rechargeable battery may include any type of rechargeable battery, such as but not limited to a lithium-ion battery (e.g., a rechargeable lithium-manganese dioxide battery), lithium-ion polymer battery, nickel-zinc battery, nickel-metal hydride battery, nickel cadmium battery, rechargeable alkaline battery, a combination thereof, or any other type of rechargeable battery.

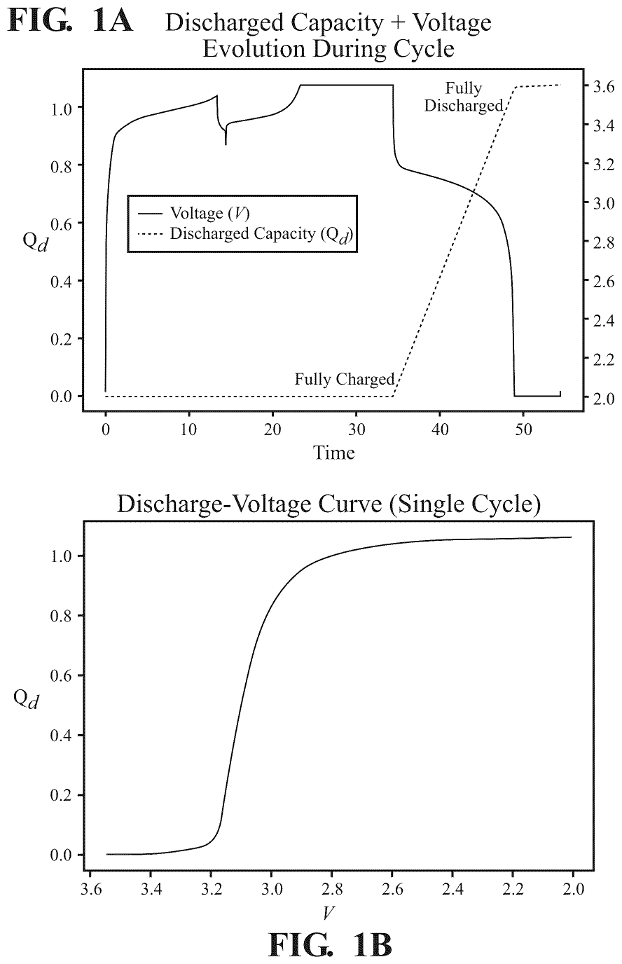

With respect to FIG. 1A, an example of a charging and discharging cycle of a rechargeable battery is shown. From 0 seconds to around 23 seconds, the rechargeable battery is shown as being charged from 2.0 V to 3.6 V. Thereafter, from around 32 seconds to 49 seconds, the rechargeable battery is shown as being discharged from 3.6 V to 2.0 V. Based on the discharge curve, a discharged capacity curve can be added that has a value of 0 when the discharging cycle begins (e.g., around 32 seconds) and a value of 1 when the discharging cycle ends (e.g., around 49 seconds). Once a discharged capacity curve is generated, a discharged capacity vs. voltage curve (“discharge-voltage curve”) may be generated as shown in FIG. 1B.

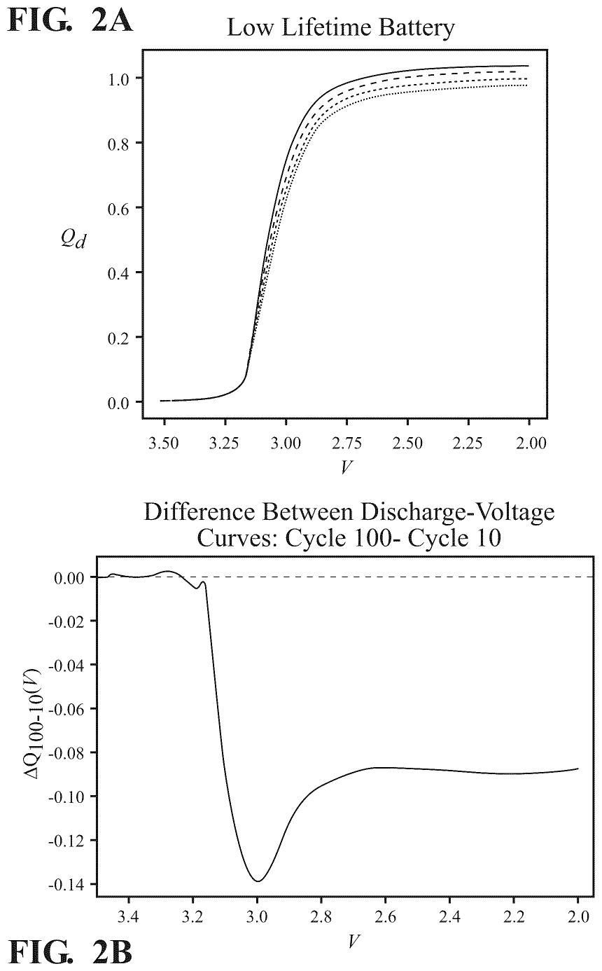

With each charge and discharge cycle of the rechargeable battery, the alteration of physical properties within the rechargeable battery may cause a unique discharge-voltage curve to arise with respect to each discharge cycle. For example, as shown in FIG. 2A, the discharged capacity of a rechargeable battery may decrease with each discharging cycle. Accordingly, as shown in FIG. 2B, a differential discharge-voltage curve may be generated showing the difference between a first and a second discharge-voltage curve at, respectively, a first and a second number of discharging cycles (e.g., Q_{d}(V) for 10 cycles of discharging vs. Q_{d}(V) at 100 cycles of discharging). For example, FIG. 2B shows an example of a differential discharge-voltage curve ΔQ₁₀₀₋₁₀(V) for a rechargeable battery, which demonstrates that between the 10th and 100th cycle of discharging the rechargeable battery a decline in terms of the discharge capacity reaches a peak of −0.14 at around 3.0 V.

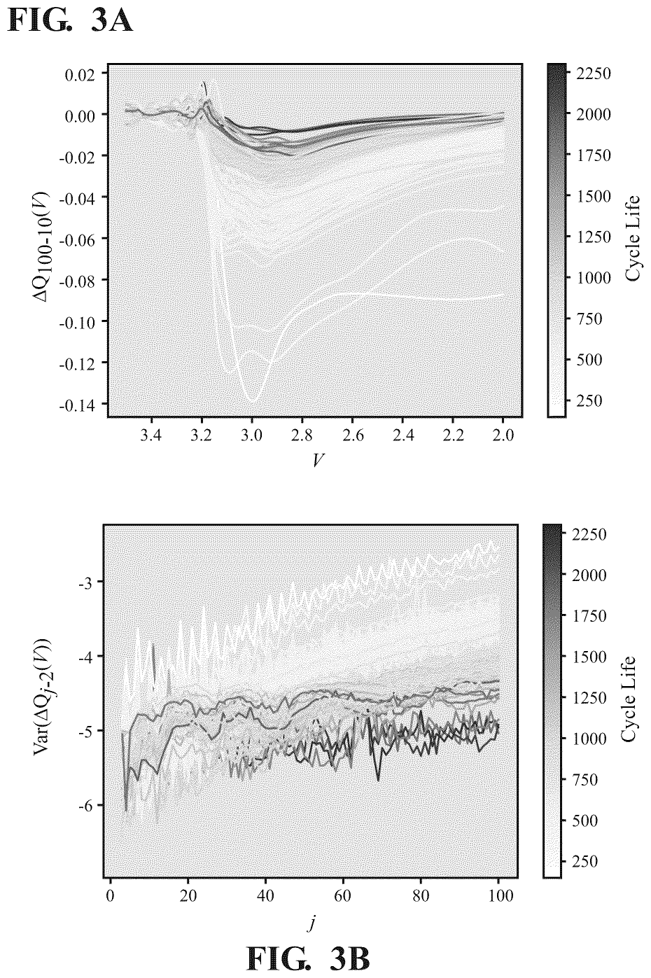

In addition to the alteration of physical properties within a rechargeable battery due to each cycle of charging and discharging, the manufacturing of each rechargeable battery or other factors may also cause a rechargeable battery to have a unique set of discharge-voltage curves as compared to other rechargeable batteries. As such, each rechargeable battery may also have a unique set of different differential discharge-voltage curves. For example, as shown in FIG. 3A, a set of differential discharge-voltage curves ΔQ₁₀₀₋₁₀(V) for a set of batteries is shown. Further, as shown in FIG. 3B, the variance of each differential discharge-voltage curve ΔQ₁₀₀₋₁₀(V) for each battery may also be determined.

While the examples provided above with respect to FIGS. 3A-B describes differential discharge-voltage curves in regard to the 100th cycle vs. the 10th cycle of a battery, a sequence of differential discharge-voltage curves using a range of discharge cycles may be generated for each rechargeable battery. For example, for each rechargeable battery a set of differential discharge-voltage curves A may be obtained according to the following equation:

$$A = \{ Δ {Q}_{j - a} ( V ) ; j = a + 1 , … , b \} , \qquad Equation ( 1 )$$

where a denotes the baseline discharge cycle (e.g., a=2) and b denotes the discharge cycle for comparison (e.g., b=100).

In addition, for each rechargeable battery a set of variance curves B based on the set of differential discharge-voltage curves A may be obtained according to the following equation:

$$B = \{ Var ( Δ {Q}_{j - a} ( V ) ) ; j = a + 1 , … , b \} , \qquad Equation ( 2 )$$

where again α denotes the baseline discharge cycle (e.g., a=2) and b denotes the discharge cycle for comparison (e.g., b=100).

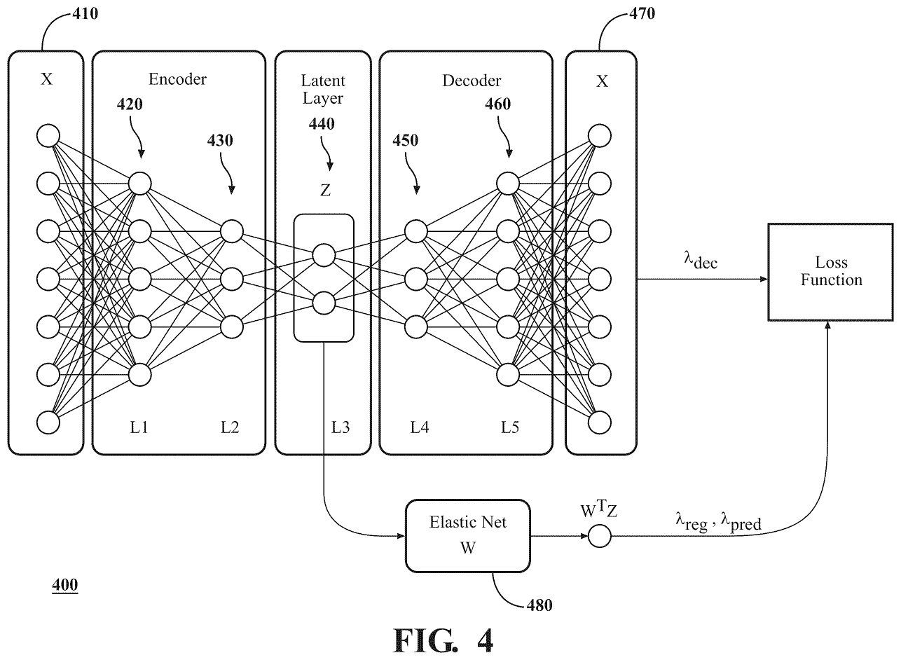

With respect to FIG. 4, an example of a two-headed autoencoder 400 is shown that may be used for predicting the cycle life of batteries, where X and \hat{X} respectively represent the model's input and its reconstructed output. Two-headed autoencoder 400 may be comprised of input 410, first encoder layer 420, second encoder layer 430, latent layer 440, first decoder layer 450, second decoder layer 460, and output 470. Latent layer 440 may also be coupled to elastic net 480.

In some embodiments, two-headed autoencoder 400 may be trained based on one or more sets of variance curves (e.g., {Var(ΔQⱼ₋ₐ(V)); j=a+1, . . . , b}) as an input sequence x. For example, the weights of two-headed autoencoder 400 may encode an input sequence x within input 410 via first encoder layer 420 and second encoder layer 430 to obtain a latent vector z in latent layer 440. In addition, the weights of the two-headed autoencoder 400 may decode the latent vector z in latent layer 440 via first decoder layer 450 and second decoder layer 460 to provide an output sequence \hat{x} within output 470.

It should be understood that that the length of the input vector, output vector, and number of hidden nodes per layer is exemplary and that such parameters may be adjusted as desired with respect to two-headed autoencoder 400. In addition, it should be understood that the number of encoder/decoder layers is also exemplary and may also be adjusted as desired with respect to two-headed autoencoder 400 (e.g., two-headed autoencoder 400 may utilize three encoder layers and three decoder layers).

Elastic net 480 as shown in FIG. 4 may apply a set of prediction head parameters w to the latent vector z in latent layer 440 to obtain a prediction of the battery life for a rechargeable as follows:

$$\hat{y} = {w}^{T} z , \qquad Equation ( 3 )$$

which may be compared with the actual battery life y for the rechargeable battery.

Based on the values of x, z, \hat{x}, y, and ŷ obtained with respect to a set of rechargeable batteries, a set of loss terms may be obtained for training the two-headed autoencoder 400. First, an autoencoder loss L_{dec} may be obtained as follows:

$${L}_{d e c} = \frac{{λ}_{dec}}{B} {\sum }_{i = 1}^{B} {‖ {x}_{i} - {\hat{x}}_{i} ‖}_{2}^{2} , \qquad Equation ( 4 )$$

where λ_{dec} denotes autoencoder loss sensitivity hyperparameter, B denotes the batch size, xᵢ denotes the input sequence x corresponding to the ith rechargeable battery, and \hat{x}ᵢ denotes the output sequence \hat{x} corresponding to the ith rechargeable battery. Autoencoder loss sensitivity hyperparameter may be selected to increased or decreased the sensitivity of the training algorithm to autoencoder loss L_{dec}. B may be selected to determine the number of rechargeable batteries used to determine autoencoder loss L_{dec}.

Next, an initial prediction loss L_{pred} may be obtained as follows:

$${L}_{pred} = \frac{{λ}_{pred}}{B} {\sum }_{i = 1}^{B} {( 1 {0}^{{y}_{i}} - 1 {0}^{{w}^{T} {z}_{i}} )}^{2} , \qquad Equation ( 5 )$$

where λ_{pred} denotes initial prediction loss sensitivity, hyperparameter B denotes the batch size (e.g., 64), yᵢ denotes the actual battery life corresponding to the ith rechargeable battery (e.g., 502 cycles), w denotes the prediction head parameters, and zᵢ denotes the latent vector z corresponding to the ith rechargeable battery. Initial prediction loss sensitivity hyperparameter may be selected to increased or decreased the sensitivity of the training algorithm to initial prediction loss L_{pred}. B may be selected to determine the number of rechargeable batteries used to determine initial prediction loss L_{pred}.

In addition, an elastic net regularization metric P(w) may be obtained as follows:

$$P ( w ) = \frac{1 - α}{2} {‖ w ‖}_{2} + α {‖ w ‖}_{1} , \qquad Equation ( 6 )$$

where α denotes a regularization hyperparameter (e.g., 0.5) and w denotes the prediction head parameters.

Based on the results of Equation (4), Equation (5), and Equation (6), the loss L for training the two-headed autoencoder may be obtained as follows:

$$L = {L}_{dec} + {L}_{pred} + {λ}_{reg} P ( w ) , \qquad Equation ( 7 )$$

where λ_{reg} denotes a regularization sensitivity hyperparameter that may be selected to increase or decrease the sensitivity of the training algorithm to elastic net regularization P(w).

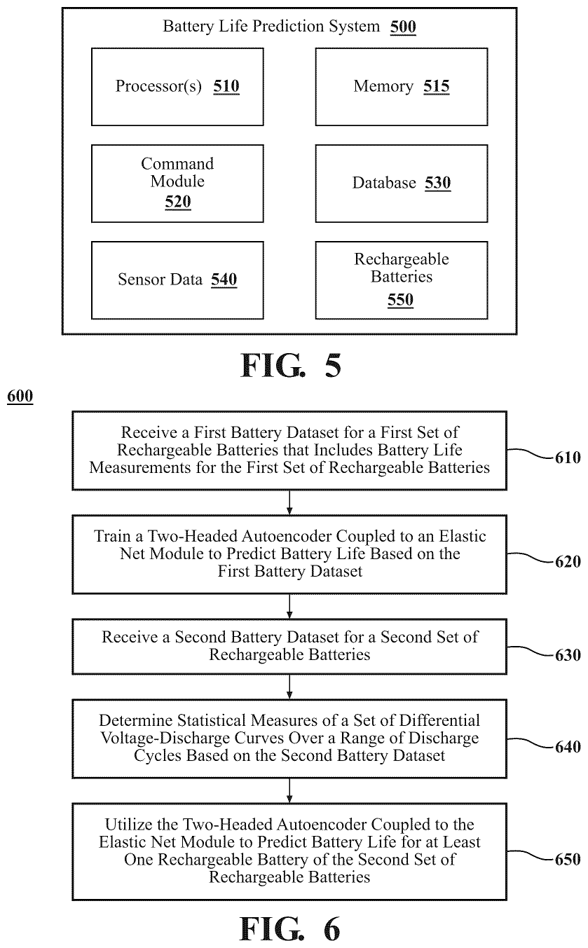

With reference to FIG. 5, one embodiment of battery life prediction system 500 is illustrated. Battery life prediction system 500 is shown as including processor(s) 510. Accordingly, processor(s) 510 may be a part of battery life prediction system 500 or battery life prediction system 500 may access processor 510 (s) through a data bus or another communication path. In one embodiment, battery life prediction system 500 includes memory 515, which stores command module 520. Memory 515 is a random-access memory (RAM), read-only memory (ROM), a hard-disk drive, a flash memory, or other suitable memory for command module 520. Command module 520 are, for example, computer-readable instructions that when executed by processor(s) 510 cause processor(s) 510 to perform the various functions disclosed herein.

Battery life prediction system 500 as illustrated in FIG. 5 is generally an abstracted form of battery life prediction system 500 as may be implemented between processor(s) 510 and a cloud-computing environment. Accordingly, battery life prediction system 500 may be embodied at least in part within a cloud-computing environment to perform the methods described herein.

Command module 520 generally includes instructions that function to control processor(s) 110 to receive data inputs, such as rechargeable battery information or modeling data as described herein. Moreover, in one embodiment, battery life prediction system 500 includes a database 530. Database 530 is, in one embodiment, an electronic data structure stored in memory 515 or another data store and that is configured with routines that may be executed by processor(s) 510 for analyzing stored data, providing stored data, organizing stored data, and so on. Thus, in one embodiment, database 530 stores data used by command module 520 in executing various functions. In one embodiment, database 530 includes sensor data 540 along with, for example, metadata that characterize various aspects of sensor data 540. For example, the metadata may include time/date stamps from when sensor data 540 was generated. Sensor data 540 may receive measurements from rechargeable batteries 550 via instructions by command module 520 to obtain such measurements or from another source (e.g., cloud-computing environment) operatively coupled to communicate with battery life prediction system 500. In some embodiments, command module 520 may also instruct battery life prediction system 500 to charge or discharge rechargeable batteries 550 so as to obtain measurements from the rechargeable batteries (e.g., battery voltages, time).

FIG. 6 illustrates a flowchart of a method 600 that is associated with battery life prediction strategies. Method 600 will be discussed from the perspective of the battery life prediction system 500. While method 600 is discussed in combination with the battery life prediction system 500, it should be appreciated that the method 600 is not limited to being implemented within battery life prediction system 500 but is instead one example of a system that may implement method 600.

At 610, command module 520 may receive a first battery dataset for a first set of rechargeable batteries that includes battery life measurements for the first set of rechargeable batteries. For example, a set of lithium ion batteries may have been tested until they reached the end of their battery lives. The voltage measurements of the discharge cycles, plus any other associated battery measurements, for each battery over its battery life may then be added to a first battery data. The battery dataset may be received from sensor data 540.

At 620, command module may train a two-headed autoencoder coupled to an elastic net module (e.g., two-headed autoencoder 400) to predict battery life based on the first battery dataset. Such training may be based on a loss function based on an autoencoder loss, an initial prediction loss, and an elastic net regularization metric as described herein. Such training may also involve adjustments to an autoencoder loss sensitivity hyperparameter, an initial prediction loss sensitivity hyperparameter, an elastic net regularization metric sensitivity hyperparameter, or a combination thereof to adjust the sensitivity of the training to the terms of the loss function associated with each sensitivity hyperparameter. The training may be performed using optimization algorithms well known in the art, such as an Adam optimizer.

At 630, command module 520 may receive a second battery dataset for a second set of rechargeable batteries. For example, upon rechargeable batteries 550 receiving a set of new rechargeable batteries, command module 520 may perform tests to obtain battery measures for a desired range of discharge cycles (e.g., from 2 to 100). These battery measures may then be used by command module 520 to generate voltage-discharge curves and differential voltage-discharge curves.

At 640, command module 520 may determine statistical measures of a set of differential voltage-discharge curves over a range of discharge cycles based on the second battery dataset. For example, command module 520 may determine the variances of the differential voltage-discharge curves obtained in step 630.

At 650, command module 520 may utilize the two-headed autoencoder coupled to the elastic net module to predict battery life for at least one rechargeable battery of the second set of rechargeable batteries. For example, command module may apply the variances of the differential voltage-discharge curves as an input to the trained two-headed autoencoder to receive an estimate of battery life.

In some embodiments, if a predicted battery life does not satisfy a battery life criteria (e.g., battery life is at least 500 cycles; battery life is at least 700 cycles if current draw has not exceeded 20A) command module may instruct that the associated rechargeable battery to be excluded from rechargeable batteries 550. In some embodiments, command module 520 may add battery measurements of a rechargeable battery from the second battery dataset to the first battery dataset when its battery life is exhausted.

Battery life prediction system 500 may include one or more modules, at least some of which are described herein. The modules may be implemented as computer-readable program code that, when executed by processor(s) 510, implement one or more of the various processes described herein. One or more of the modules may be a component of processor(s) 510, or one or more of the modules may be executed on or distributed among other processing systems to which processor(s) 510 is operatively connected. The modules may include instructions (e.g., program logic) executable by processor(s) 510.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
receive a first battery dataset for a first set of rechargeable batteries that includes battery life measurements for the first set of rechargeable batteries; and
train a two-headed autoencoder coupled to an elastic net module to predict battery life based on the first battery dataset, wherein the two-headed autoencoder when trained is capable of:
receiving a second battery dataset for a second set of rechargeable batteries;
determining statistical measures of a set of differential voltage-discharge curves over a range of discharge cycles based on the second battery dataset; and
utilizing the two-headed autoencoder to predict battery life for at least one rechargeable battery of the second set of rechargeable batteries.

2. The system of claim 1, wherein the machine-readable instructions to train the two-headed autoencoder coupled to an elastic net module utilizes a loss function based on an autoencoder loss, an initial prediction loss, and an elastic net regularization metric.

3. The system of claim 2, wherein the autoencoder loss, the initial prediction loss, and the elastic net regularization metric can be adjusted respectively by an autoencoder loss sensitivity hyperparameter, an initial prediction loss sensitivity hyperparameter, and an elastic net regularization metric sensitivity hyperparameter.

4. The system of claim 1, wherein the machine-readable instructions that, when executed by the processor, further includes causing the processor to:
reject the at least one rechargeable battery if the battery life does not satisfy a battery life criteria.

5. The system of claim 1, wherein the range of discharge cycles begins with a second discharge cycle.

6. The system of claim 1, wherein the statistical measures of a set of differential voltage-discharge curves are variances of the set of differential voltage-discharge curves.

7. The system of claim 1, wherein the machine-readable instructions that, when executed by the processor, further includes causing the processor to:
add battery measurements of the at least one rechargeable battery to the first battery dataset when its battery life is exhausted.

8. A non-transitory computer-readable medium including instructions that when executed by one or more processors cause the one or more processors to:
receive a first battery dataset for a first set of rechargeable batteries that includes battery life measurements for the first set of rechargeable batteries; and
train a two-headed autoencoder coupled to an elastic net module to predict battery life based on the first battery dataset, wherein the autoencoder when trained is capable of:
receiving a second battery dataset for a second set of rechargeable batteries;
determining statistical measures of a set of differential voltage-discharge curves over a range of discharge cycles based on the second battery dataset; and
utilizing the two-headed autoencoder to predict battery life for at least one rechargeable battery of the second set of rechargeable batteries.

9. The non-transitory computer-readable medium of claim 8, wherein the instructions to train the two-headed autoencoder coupled to an elastic net module utilizes a loss function based on an autoencoder loss, an initial prediction loss, and an elastic net regularization metric.

10. The non-transitory computer-readable medium of claim 9, wherein the autoencoder loss, the initial prediction loss, and the elastic net regularization metric can be adjusted respectively by an autoencoder loss sensitivity hyperparameter, an initial prediction loss sensitivity hyperparameter, and an elastic net regularization metric sensitivity hyperparameter.

11. The non-transitory computer-readable medium of claim 8, further comprising instructions that when executed by one or more processors cause the one or more processors to:
reject the at least one rechargeable battery if the battery life does not satisfy a battery life criteria.

12. The non-transitory computer-readable medium of claim 8, wherein the statistical measures of a set of differential voltage-discharge curves are variances of the set of differential voltage-discharge curves.

13. The non-transitory computer-readable medium of claim 8, further comprising instructions that when executed by one or more processors cause the one or more processors to:
add battery measurements of the at least one rechargeable battery to the first battery dataset when its battery life is exhausted.

14. A method, comprising:
receiving a first battery dataset for a first set of rechargeable batteries that includes battery life measurements for the first set of rechargeable batteries; and
training a two-headed autoencoder coupled to an elastic net module to predict battery life based on the first battery dataset, such that the two-headed autoencoder when trained is capable of:
receiving a second battery dataset for a second set of rechargeable batteries;
determining statistical measures of a set of differential voltage-discharge curves over a range of discharge cycles based on the second battery dataset; and
utilizing the two-headed autoencoder to predict battery life for at least one rechargeable battery of the second set of rechargeable batteries.

15. The method of claim 14, wherein training the two-headed autoencoder coupled to an elastic net module utilizes a loss function based on an autoencoder loss, an initial prediction loss, and an elastic net regularization metric.

16. The method of claim 15, wherein the autoencoder loss, the initial prediction loss, and the elastic net regularization metric can be adjusted respectively by an autoencoder loss sensitivity hyperparameter, an initial prediction loss sensitivity hyperparameter, and an elastic net regularization metric sensitivity hyperparameter.

17. The method of claim 14, further comprising rejecting the at least one rechargeable battery if the battery life does not satisfy a battery life criteria.

18. The method of claim 14, wherein the range of discharge cycles begins with a second discharge cycle.

19. The method of claim 14, wherein the statistical measures of a set of differential voltage-discharge curves are variances of the set of differential voltage-discharge curves.

20. The method of claim 14, further comprising adding battery measurements of the at least one rechargeable battery to the first battery dataset when its battery life is exhausted.
